(19) United States
(12) Patent Application Publication
(10) Pub. No.: US 2024/0359160 A1
(43) Pub. Date: Oct. 31, 2024

(54) COMPOSITE COMPRISING A LIQUID CRYSTALALLINE COMPOUND AND AN ANISOTROPIC METAL ORGANIC FRAMEWORK PARTICLE, AND A LAMINATE COMPRISING THE SAME

(71) Applicant: KOREA ADVANCED INSTITUTE OF SCIENCE AND TECHNOLOGY, Daejeon (KR)

(72) Inventors: Dong Ki YOON, Daejeon (KR); Gaehyun PARK, Daejeon (KR); Yeongseo BAK, Daejeon (KR); Geonhyeon PARK, Daejeon (KR)

(21) Appl. No.: 18/587,269

(22) Filed: Feb. 26, 2024

(30) Foreign Application Priority Data
Apr. 26, 2023 (KR) 10-2023-0054559

(51) Int. Cl. B01J 20/22; B01D 53/22; B01D 69/12; B01D 69/14; B01D 71/58; B01J 20/28; B01J 20/30

(52) U.S. Cl. CPC B01J 20/226; B01D 53/228; B01D 69/1213; B01D 69/147; B01D 71/58; B01J 20/28004; B01J 20/28016; B01J 20/28026; B01J 20/28035; B01J 20/2808; B01J 20/28083; B01J 20/3007; B01J 20/3057; B01J 20/3085; B01D 2053/221

(57) ABSTRACT

The present invention relates to a composite characterized by comprising an aromatic liquid crystalline compound and a metal organic framework containing an anisotropic metal organic framework particle, wherein the anisotropic metal organic framework particle is reversibly switched between isotropy and anisotropy oriented in one direction; and a laminate comprising the composite. The composite of the present invention can orient the metal organic framework in one direction, and can precisely control the orientation direction.

### CROSS REFERENCE TO RELATED APPLICATION

The present application claims the priority of Korean Patent Application No. 10-2023-0054559, filed on Apr. 26, 2023, the entire contents of which is incorporated herein for all purposes by this reference.

### BACKGROUND OF THE INVENTION

### Field of the Invention

The present invention relates to a composite comprising a liquid crystalline compound and an anisotropic metal organic framework particle, and a laminate comprising the same.

### Description of the Related Art

A metal organic framework (MOF) is a crystalline material in which a particle containing a metal or a metal ion is linked by an organic ligand, and has a three-dimensional porous structure. Even though the metal organic framework contains a plurality of pores, it maintains a strong bond between the metal and the organic polymer and has very excellent durability. Due to such a characteristic, the metal organic framework has a wide range of applications such as storage of ions and molecules through the pores, a catalyst, a drug delivery, and a chemical sensor. In particular, the metal organic framework shows excellent performance as a separation membrane for separating a gas mixture, which is important to align the metal organic framework in one direction to improve the performance of the separation membrane.

In the past, as a method for aligning the metal organic framework, the metal organic framework was grown on a crystalline substrate to provide orientation. However, it was difficult to separate the metal organic framework from the substrate, and because a combination of the metal organic framework and the substrate that can provide orientation was very limited, there was a limit to orienting various types of the metal organic frameworks. In order to settle these problems, a method of first growing the metal organic framework and then orienting the metal organic framework by applying an external magnetic field or electric field was developed. However, since the metal organic framework does not have the magnetic field or the electric field, it has a disadvantage of requiring an additional additive. Accordingly, there is a need for research on a method for easily orienting the metal organic framework in one direction, regardless of a type of the metal organic framework.

### SUMMARY OF THE INVENTION

In order to solve the problems of the prior art, the purpose of the present invention is to provide a composite that can orient a metal organic framework in one direction.

A composite according to the present invention comprises an aromatic liquid crystalline compound and a metal organic framework containing an anisotropic metal organic framework particle, wherein the metal organic framework is reversibly switched between isotropy and anisotropy oriented in one direction.

In the composite according to the present invention, the aromatic liquid crystalline compound may contain a thermotropic liquid crystalline compound.

In the composite according to the present invention, the metal organic framework may have anisotropy at a temperature lower than the phase transition temperature of the aromatic liquid crystalline compound.

In the composite according to the present invention, the anisotropic metal organic framework particle may be in the form of a rod.

In the composite according to the present invention, an aspect ratio of the anisotropic metal organic framework particle may be 3 to 15.

In the composite according to the present invention, the anisotropic metal organic framework particle may have an average pore size of 1 to 5 nm in a longitudinal direction thereof.

In the composite according to the present invention, the anisotropic metal organic framework particle may be uniformly dispersed in the aromatic liquid crystalline compound.

In the composite according to the present invention, the aromatic liquid crystalline compound may have a nematic phase at a temperature lower than the phase transition temperature.

In the composite according to the present invention, the aromatic liquid crystalline compound further contains a polymerizable functional group, and the anisotropic metal organic framework particle may be fixedly oriented in one direction within an aromatic liquid crystalline polymer matrix formed by polymerizing the aromatic liquid crystalline compound.

A laminate according to the present invention comprising: a lower substrate; an upper substrate arranged apart opposite to the lower substrate; a lower orientation membrane located on a top of the lower substrate; an upper orientation membrane located on a bottom of the upper substrate; and a composite interposed between the lower orientation membrane and the upper orientation membrane,
wherein the composite comprises an aromatic liquid crystalline compound and a metal organic framework containing an anisotropic metal organic framework particle, the metal organic framework being reversibly switched between isotropy and anisotropy oriented in one direction.

In the laminate according to the present invention, the metal organic framework of the composite may be oriented in a plane direction of the substrate or in a vertical direction of the substrate.

In the laminate according to the present invention, a thickness of the composite may be 20 to 80 μm.

In the laminate according to the present invention, the orientation membranes may contain a plurality of grooves oriented in one direction.

In the laminate according to the present invention, the upper orientation membrane and the lower orientation membrane may include one or more selected from the group comprising a first orientation membrane that does not contain the groove; a second orientation membrane that contains a plurality of grooves oriented in one direction; and a third orientation membrane that contains a plurality of grooves oriented in a direction different from the second orientation membrane.

A method for preparing the laminate according to the present invention comprises the steps of: (S10) arranging an upper substrate and a lower substrate apart from each other so that an upper orientation membrane formed on one surface of the upper substrate is opposite to a lower orientation membrane formed on one surface of the lower substrate; and (S20) injecting a composite between the lower orientation membrane and the upper orientation membrane, wherein the composite comprises an aromatic liquid crystalline compound and a metal organic framework containing an anisotropic metal organic framework particle.

In the method for preparing the laminate according to the present invention, the method may further comprise, before the step (S10), the steps of coating an anchoring polymer on one surface of the upper substrate and the lower substrate; and preparing the upper orientation membrane and the lower orientation membrane by forming a plurality of grooves oriented in one direction to the anchoring polymer.

In the method for preparing the laminate according to the present invention, the step (S20) may be performed at a temperature higher than the phase transition temperature of the aromatic liquid crystalline compound.

In the method for preparing the laminate according to the present invention, the method may further comprise, after the step (S20), the step of polymerizing the aromatic liquid crystalline compound at a temperature lower than the phase transition temperature.

A separation membrane according to the present invention comprises a porous support and an active layer located on the porous support and containing a composite, wherein the composite comprises an aromatic liquid crystalline compound and a metal organic framework containing an anisotropic metal organic framework particle, the metal organic framework being reversibly switched between isotropy and anisotropy oriented in one direction.

The composite comprising the liquid crystalline compound and the anisotropic metal organic framework and the laminate comprising the same according to the present invention can orient the anisotropic metal organic framework in one direction.

Further, it is possible to provide the composite that can exactly control a direction to which the metal organic framework is oriented.

### BRIEF DESCRIPTION OF THE DRAWINGS

FIG. 1 is a diagram showing a change in orientation of a composite according to an embodiment.

FIG. 2 is an image of an optical microscope of a metal organic framework according to an embodiment.

FIG. 3 is an image of a scanning electron microscope (SEM) of a metal organic framework according to an embodiment.

FIG. 4A is a schematic diagram showing a laminate according to an embodiment.

FIG. 4B is an image of an optical microscope showing a change in orientation of a metal organic framework according to an embodiment.

FIG. 5A is a schematic diagram showing a laminate according to an embodiment.

FIG. 5B is an image of a polarized optical microscope of a composite according to an embodiment.

FIG. 6A is a schematic diagram showing a laminate according to an embodiment.

FIG. 6B is an image of an optical microscope according to an embodiment of the orientation direction of the laminate.

FIG. 6C is an image of a fluorescence microscope according to an embodiment of the orientation direction of the laminate.

FIGS. 7 and 8 are images of a polarized optical microscope of a composite according to an embodiment.

FIGS. 9A and 10A are images of a scanning electron microscope (SEM) of a composite according to an embodiment.

FIGS. 9B and 10B are mapping images of an energy-dispersive X-ray spectroscopy (EDS) of a composite according to an embodiment.

FIGS. 11A and 11B are a schematic diagram showing a separation membrane according to an embodiment.

### DETAILED DESCRIPTION OF THE INVENTION

A composite comprising a liquid crystalline compound and an anisotropic metal organic framework and a laminate comprising the same according to the present invention will be described in detail. The terms used in the specification were selected as general terms that are currently widely used as many as possible while considering a function of the present invention, but these terms may vary depending on an intention or precedent of a technician working in the relevant field and emergence of the new technologies, etc. Unless otherwise defined, the used technical and scientific terms may have meanings that are commonly understood by a person who has an ordinary skill in the technical field to which the present invention belongs.

In the specification and appended claims of the subject application, the term such as “comprise” or “have” refers to presence of the features or constitutive elements described in the specification, and does not preclude the possibility of additionally including one or more other features or constitutive elements, unless being specifically limited thereto.

In the specification and appended claims of the subject application, the terms such as “first” and “second” are not used as a limiting sense, but used for the purpose of distinguishing one constitutive element from other constitutive element.

As used in the specification and appended claims of the subject application, a singular expression also includes a plural expression, unless the context clearly dictates the singular. Likewise, a plural expression also includes a singular expression, unless the context clearly dictates the plural.

Further, the numerical range used in the specification of the subject application includes a lower and upper limit thereof and all values within the range of the lower and upper limits, an increment logically derived from the form and width of the defined range, all values defined doubly, and all possible combinations of the upper and lower limits of a numerical range defined in a different form. Unless specifically defined in the specification of the present invention, a value outside the numerical range that are likely to result from an experimental error or rounding of the value is also included within the numerical range as defined.

The term “about” or the like used in specification and appended claims of the subject application is used to cover a tolerance when the tolerance exists.

A metal organic framework (MOF) is a crystalline material to which a particle containing a metal, a metal ion, or an ion cluster is linked by an organic ligand, and has a three-dimensional porous structure. Although the metal organic framework contains a plurality of pores, it provides very excellent durability by virtue of a strong bond between the metal and the organic polymer. Therefore, the metal organic framework has a wide range of applications such as a separation membrane, a catalyst, a drug delivery, and a chemical sensor.

In particular, in case the metal organic framework is used as the separation membrane, it is important to align the metal organic framework in one direction to improve permeability of a substance. Conventionally, an Epitaxial growth method was used in order to prepare the metal organic framework oriented in one direction, the method comprising: growing the metal organic framework on a crystalline substrate, and separating the metal organic framework from the substrate to orient the metal organic framework. However, a combination of the substrate and the metal organic framework that can be grown by the Epitaxial growth method was limited, and there was a problem in that it is difficult to separate the prepared metal organic framework from the substrate. Accordingly, the present applicant has succeeded in preparing a composite that can easily orient the metal organic framework in one direction by only regulating a temperature, regardless of a type of the metal organic framework.

A composite according to the present invention is characterized by comprising an aromatic liquid crystalline compound and a metal organic framework containing an anisotropic metal organic framework particle, wherein the metal organic framework is reversibly switched between isotropy and anisotropy oriented in one direction.

As the anisotropic metal organic framework particle is uniformly dispersed in the aromatic liquid crystalline compound to orient the aromatic liquid crystalline compound in one direction, the metal organic framework can also be oriented in the same direction as that of the aromatic liquid crystalline compound. The orientation of the metal organic framework is induced depending on a direction to which the aromatic liquid crystalline compound is oriented, so that the material can be oriented regardless of a type of the anisotropic metal organic framework, and the direction to which the material is oriented can also be easily controlled.

Specifically, the aromatic liquid crystalline compound may contain a thermotropic liquid crystalline compound. The thermotropic liquid crystalline compound may exhibit isotropy at a temperature higher than the phase transition temperature thereof, but may show anisotropy at a temperature lower than the phase transition temperature. More specifically, the thermotropic liquid crystalline compound may be converted to a nematic phase at a temperature lower than the phase transition temperature.

The nematic phase refers to a state in which each position of the molecules is irregular but has a constant orientation. As the aromatic liquid crystalline compound converts into an anisotropic nematic phase at a temperature lower than the phase transition temperature, the metal organic framework uniformly dispersed in the aromatic liquid crystalline compound is also oriented in the same direction as that of the aromatic liquid crystalline compound, which results in having anisotropy.

In an embodiment, the aromatic liquid crystalline compound may include an aromatic liquid crystalline compound having a nematic phase at a temperature lower than the phase transition temperature, for example, 4′-pentyl-4-biphenylcarbonitrile (5CB) or 4′-octyl-4-biphenylcarbonitrile (8CB).

As an example, the aromatic liquid crystalline compound may further contain a polymerizable functional group. Since the polymerizable functional group is polymerized within the aromatic liquid crystalline compound to form an aromatic liquid crystalline polymer matrix, the anisotropic metal organic framework particle can be fixedly oriented within the aromatic liquid crystalline polymer matrix in one direction. A composite comprising the aromatic liquid crystalline polymer matrix and the metal organic framework is particularly advantageous because it can selectively transmit specific gas substances contained in a gas mixture.

Illustratively, the polymerizable functional group may contain a reactive mesogen group such as an acrylate group. A typical aromatic liquid crystalline compound containing the reactive mesogen group may include 1,4-bis-[4-(3-acryloyloxypropyloxy)benzoyloxy]-2-methylbenzene (RM257), 1,4-bis-[4-(3-acryloyloxypropyloxy)benzoyloxy]-2-methylbenzene (RM82), 2-methyl-1,4-phenylenebis(4-(((4-(acryloyloxy) butoxy) carbonyl)oxy) benzoate (LC242), etc.

If the aromatic liquid crystalline compound is oriented in one direction, the metal organic framework is induced and oriented in the same direction as that of the aromatic liquid crystalline compound, so that the metal organic framework has anisotropy regardless of a specific material type of the metal organic framework, which results in having excellent versatile applications.

In an embodiment, the anisotropic metal organic framework particle may be in the form of a rod, and an aspect ratio of the anisotropic metal organic framework particle may be 2 or more, may be specifically 3 to 15 or 4 to 12, and may be preferably 5 to 8. A composite comprising the rod-shaped anisotropic metal organic framework particle is oriented in one direction at a temperature lower than the phase transition temperature, so that a pore contained in the metal organic framework particle can form a channel in a longitudinal direction of the metal organic framework. As the pore of the metal organic framework is aligned in one direction, a rate at which a substance permeates through the channel can be advantageously improved.

In an embodiment, an average pore size of the anisotropic metal organic framework particle in a longitudinal direction may be 1 to 5 nm or 1 to 4 nm, and preferably may have an average pore size of 1 to 3 nm, but the present invention may vary, without being limited thereto, depending on a type of an organic ligand contained in the metal organic framework. The metal organic framework having a pore size in the above range is advantageous because it can selectively separate and store a substance in its molecular level.

In an embodiment, the metal organic framework may include a node containing a cluster obtained by reacting a metal or a metal ion with acetate, and an organic ligand connecting the node. The node may include the metal such as copper (Cu), zinc (Zn), iron (Fe), zirconium (Zr), nickel (Ni), cobalt (Co) and aluminum (Al), or include the metal ion. The organic ligand may be any organic compound containing a functional group capable of forming a coordination bond. For example, the organic ligand may include a carboxyl group (—COOH), an amine group (—NH₂), an imino group (—NH), a nitro group (—NO₂), a hydroxy group (—OH), a halogen group (—X), a sulfonic acid group (—SO₃H), a methanedithioic acid group (—CS₂H), a pyridine group, or a combination thereof.

As a more specific example, the metal organic framework may include NU-1000 (Zr₆O₄(OH):(H₂O)₄ (TBAPy)₂, TBAPy=1,3,6,8-tetrakis(p-benzoicacid) pyrene), Cu₃(hhtp)₂ (Cu₃ (2,3,6,7,10,11-hexahydroxytriphenylene)₂), MOF-5 (Zn₄O(BDC)₃, BDC=1,4-benzodicarboxylate), MIL-53 (C₈H₅AlO₅), HKUST-1 (Cu₃ (BTC)₂:(H₂O)₃, BTC=benzenetricarboxylate), UIO-66 (Zr₆ (μ₃—O)₄ (μ₃—OH)₄ (CO₂)₁₂), KAUST-7 ([Ni(C₄H₄N₂)₂](NbOF₅)), [Cu₂(bza)₄ (pyz)]ₙ (bza=benzolate, pyz=pyrazine), or a derivative thereof, but the present invention is not limited thereto and may include any metal organic framework known in the art.

The present invention includes a laminate and a separation membrane that comprise the above-described composite.

The laminate according to the present invention comprising: a lower substrate; an upper substrate arranged apart opposite to the lower substrate; a lower orientation membrane located on a top of the lower substrate; an upper orientation membrane located on a bottom of the upper substrate; and a composite interposed between the lower orientation membrane and the upper orientation membrane.

As described above, the composite comprising the anisotropic metal organic framework particle uniformly dispersed in the aromatic liquid crystalline compound can be interposed between the lower orientation membrane and the upper orientation membrane to orient the composite in a plane direction of the substrate or in a vertical direction of the substrate.

Specifically, In case the upper orientation membrane and the lower orientation membrane do not include a groove, the composite can be oriented in a vertical direction of the substrate at a temperature lower than the phase transition temperature. On the other hand, in case the upper orientation membrane and the lower orientation membranes include a plurality of grooves oriented in one direction, the composite may be oriented in a plane direction of the substrate, and the grooves and a long axis of the metal organic framework can be oriented in the same orientation direction as each other.

In an embodiment, the upper orientation membrane and the lower orientation membrane may include one or more selected from the group comprising a first orientation membrane that does not contain a groove, a second orientation membrane that contains a plurality of grooves oriented in one direction, and a third orientation membrane that contains a plurality of grooves oriented in a different direction from the second orientation membrane. The first orientation membrane to the third orientation membrane may be appropriately selected depending on the desired orientation direction.

As an example, in case different types of the orientation membranes are continuously arranged in parallel, the metal organic framework may have different orientation directions within the composite.

As a non-limiting and specific example, the metal organic framework particle may emit fluorescence when oriented in a direction parallel to a polarizing plate. In a laminate in which two or more orientation membranes selected from the group comprising the second orientation membrane and the third orientation membrane, which contain the orientation direction of the grooves different from each other, and the first orientation membrane, which does not contain the groove, are arranged in parallel, in case there is no the polarizing plate, all the metal organic framework particles emit light to make it impossible to observe a pattern regardless of the orientation direction of the composite included in the laminate. However, in case the laminate is observed through the polarizing plate, only the metal organic framework particle oriented parallel to the polarizing plate emit light to make it possible to form a specific pattern. If the laminate exhibiting the specific pattern on the polarizing plate is attached to a product that requires identification, it can be easily utilized to certify the product or determine its authenticity.

In an embodiment, a thickness of the composite may be 20 to 80 μm or 30 to 70 μm, and preferably 40 to 60 μm. By means of the above thickness range, the aromatic liquid crystalline compound and the metal organic framework can be oriented in a plane direction of the substrate or in a vertical direction of the substrate to provide a space in which the metal organic framework can form a channel.

In an embodiment, the orientation membrane may include polyimide, polyamide, nylon, polyvinyl alcohol, polyethyleneimine, or Teflon, and may preferably include polyimide, but the present invention is not limited by the above specific material of the orientation membrane.

In an embodiment, the substrate may include a glass substrate, and may include a transparent polymer selected from the group comprising a polystyrene (PS) film, a polyethylene (PE) film, a polyethylene naphthalate (PEN) film, or a polyimide (PI) film, but the present invention is not limited thereto.

A method for preparing the laminate according to the present invention comprises the steps of: (S10) arranging an upper substrate and a lower substrate apart from each other so that an upper orientation membrane formed on a bottom of the upper substrate is opposite to a lower orientation membrane formed on a top of the lower substrate; and (S20) injecting a composite between the lower orientation membrane and the upper orientation membrane, wherein the composite comprises an aromatic liquid crystalline compound and an anisotropic metal organic framework particle.

More specifically, the method according to the present invention may further comprise, before the step (S10), the steps of applying an anchoring polymer on one surface of the upper substrate and the lower substrate; and preparing the upper orientation membrane and the lower orientation membrane by forming a plurality of grooves oriented in one direction to the anchoring polymer.

A method of applying the anchoring polymer may, for example, include a slit coating, a knife coating, a spin coating, a casting, a micro gravure coating, a gravure coating, a bar coating, a roll coating, a wire bar coating, a dip coating, a spray coating, etc., without being particularly limited thereto.

In an embodiment, the anchoring polymer may be a polymer with an excellent orientation control ability and an excellent chemical stability, and may specifically include, for example, polyimide or polyamide. As a more specific example, the anchoring polymer may adopt different types of polymers depending on a laminating direction of the composite, and may include, for example, a vertical anchoring polyimide (VAPI), which orients the composite in a vertical direction of the substrate. After coating a planar anchoring polyimide (PAPI), an orientation membrane containing the groove is prepared through a rubbing process, so that the composite can be oriented in a plane direction of the substrate.

The lower orientation membrane and the upper orientation membrane may be prepared by forming a plurality of grooves oriented in one direction on a surface of the orientation membrane through the rubbing process by which a surface of the anchoring polymer is rubbed in a constant direction. An orientation direction of the long axis of the metal organic framework oriented in a plane direction of the substrate may vary depending on a rubbing direction during the rubbing process.

After forming the lower orientation membrane and the upper orientation membrane on one surface of the lower substrate and the upper substrate, respectively, the lower substrate and the upper substrate can be arranged apart from each other so that the lower orientation membrane and the upper orientation membrane are opposite to each other. When arranged apart, a tape may be attached to both ends of the lower orientation membrane to provide a gap between the lower substrate and the upper substrate. Specifically, a thickness of the tape may be 20 to 80 μm or 30 to 70 μm, and may be preferably 40 to 60 μm.

A laminate can be prepared by injecting the composite into a gap between the lower orientation membrane and the upper orientation membrane.

As described above, the composite can be prepared by uniformly dispersing the anisotropic metal organic framework in the aromatic liquid crystalline compound. A process of preparing the composite may be performed at a temperature higher than the phase transition temperature of the aromatic liquid crystalline compound such that the aromatic liquid crystalline compound exhibits isotropy, whereby the metal organic framework can be uniformly dispersed within the aromatic liquid crystalline compound.

In an embodiment, the injection of the composite in the step (S20) may be performed by a means such as a capillary injection, a spin coating, a bar coating, a screen printing, etc., and may be preferably performed by the capillary injection. The injection process of the composite may be more easily performed with capillary injection at a temperature lower than the phase transition temperature of the aromatic liquid crystalline compound such that the anisotropic metal organic framework particle is oriented in one direction.

In an embodiment, in case the upper orientation membrane and the lower orientation membrane include a plurality of the grooves aligned in one direction, the composite may be injected in a vertical direction to a longitudinal direction of the grooves contained in the orientation membrane by injecting the composite between the lower orientation membrane and the upper orientation membrane. Injection of the composite in the above direction can minimize influence of the capillary flow on the orientation direction of the metal organic framework.

In an embodiment, in case the aromatic liquid crystalline compound further contains a polymerizable functional group, the method of the present invention may further comprise the step of polymerizing the aromatic liquid crystalline compound at a temperature lower than the phase transition temperature after the step (S20). The aromatic liquid crystalline polymer can be produced by irradiating light to a composite comprising the aromatic liquid crystalline compound containing an initiator and the polymerizable functional group and polymerizing the aromatic liquid crystalline compound.

In an embodiment, when producing a composite comprising the aromatic liquid crystalline compound containing the polymerizable functional group, there may be a risk that orientation of the anisotropic metal organic framework particle may be damaged during the process of polymerizing the aromatic liquid crystalline compound. In order to prevent the metal organic framework from being fixed within an aromatic liquid crystalline polymer matrix with its orientation damaged, an aromatic liquid crystalline compound that does not contain the polymerizable functional group may be further added to the composite. Therefore, the metal organic framework can be fixedly oriented within the aromatic liquid crystalline polymer matrix.

As a specific example, a mass ratio of the aromatic liquid crystalline compound included in the composite to the aromatic liquid crystalline compound containing the polymerizable functional group may be 1:4 to 30 or 1:10 to 25, and preferably 1:15 to 22. The composite configured to comprise the aromatic liquid crystalline compound containing the polymerizable functional group at the above mass ratio can not only maintain high orientation, but also improve durability by regulating a density and rigidity of the composite so that the composite is not separated from the upper orientation membrane and lower orientation membrane.

In an embodiment, the light may be in the range of an ultraviolet wavelength. More specifically, it may be light having a wavelength zone of 100 to 400 nm, 150 to 350 nm, or 200 to 300 nm, but the wavelength zone may vary depending on a type of the initiator, and is not limited to light in the specific wavelength zone.

A separation membrane according to the present invention comprises a porous support and an active layer located on the porous support, wherein the active layer includes the above-described composite.

At a temperature lower than the phase transition temperature, the metal organic framework uniformly dispersed in the aromatic liquid crystalline compound may also be oriented along the aromatic liquid crystalline compound depending on the orientation of the aromatic liquid crystalline compound. If the metal organic framework is oriented, a pore contained in the metal organic framework can be aligned along a longitudinal direction of the metal organic framework to form a channel. The present invention has an advantage in that only the substance which is intended to be separated can be selectively transmitted through the channel, and the transmitted substance can be transported along the channel at a high rate.

Further, at a temperature higher than the phase transition temperature of the aromatic liquid crystalline compound, orientation of the composite disappears and the aromatic liquid crystalline compound and the metal organic framework are randomly distributed, which results in disappearance of the channel, thereby preventing an unwanted substance from passing through.

That is, since the orientation of the composite changes reversibly depending on a change in the temperature, it is advantageous to easily control a permeability of the separation membrane.

The permeability of the composite forming an anisotropic channel can be calculated through the Kang-Jones-Nair (KJN) model represented by Equation 1, as follows:

$$\frac{{P}_{eff}}{{P}_{m}} = {[ ( 1 - \frac{cos θ}{cos θ + \frac{1}{α} sin θ} {∅}_{f} ) + \frac{{P}_{m}}{{P}_{f}} ( \frac{1}{cos θ + \frac{1}{α} sin θ} ) {∅}_{f} ]}^{- 1} \qquad [ Equation 1 ]$$

The KJN model can predict an effective permeability (Pefr) as a function of volume fraction (f) of a filler. The Pₘ and P_{f} mean the permeability of the matrix and the filler, respectively, the 0 means an orientation direction of the filler depending on a direction to which a gas flows, and the a means an aspect ratio of the filler. In the separation membrane according to the present invention, the filler may be a metal organic framework, and the matrix may be an aromatic liquid crystalline compound.

In an embodiment, in case an orientation direction of the channel formed by the composite is perpendicular to an inflow direction of the gas (θ=π/2), a movement path of the gas passing through the channel increases. On the other hand, in case an orientation direction of the channel is parallel to an inflow direction of the gas (θ=0), a movement path of the gas flowing into the separation membrane is shortened to enhance the effective permeability (P_{eff}), which allows the gas to transmit at a high rate.

In an embodiment, the porous support may include one or more selected from the group comprising a porous polymer support, a porous metal support, and a porous ceramic support. For example, the porous polymer support may include polysulfone (PSF), polyethersulphone (PES), poly (vinylidenefluoride) (PVDF), polytetrafluoroethylene (PTFE), polyimide (PI) or polyetherimide (PEI), and the porous ceramic support may include an alumina, silicon nitride, a silica, a porous silicon carbide, a zeolite, etc., and may include preferably the porous polymer support, but the present invention is not limited thereto.

Hereinafter, the present invention will be described in detail through Examples.

### Example 1

### Preparation of a Composite

0.4% by weight of Nu-1000 ((Zr₆O₄(OH)₈ (H₂O)₄ (TBAPy)₂)) powder as a metal organic framework was mixed with 4′-pentyl-4-biphenylcarbonitrile (5CB, Sigma-Aldrich), an aromatic liquid crystalline compound, to prepare a composite. The mixture was stirred for 1 hour at 50° C., which is higher than the phase transition temperature of the aromatic liquid crystalline compound, and cooled to 25° C. to prepare the composite in which the metal organic framework was uniformly dispersed in the liquid crystalline compound.

### Preparation of a Laminate

A glass substrate was washed with an aqueous solution containing 1 wt % of a detergent (Alconox), followed by being sequentially washed with acetone, ethanol, and deionized water, and then treated with an oxygen plasma for 10 minutes to clean a surface of the glass substrate. A VAPI solution (Vertical-Anchoring Polyimide, AL-60702, JSR) as an anchoring polymer was spin-coated on the cleaned glass substrate. The spin coating was performed sequentially at 500 rpm for 5 seconds, at 4000 rpm for 40 seconds, and at 500 rpm for 5 seconds. Thereafter, the glass substrate coated with the anchoring polymer was heated in an oven at 90° C. for 30 minutes, and then heated at 200° C. for 2 hours to prepare an upper substrate including an upper orientation membrane and a lower substrate including a lower orientation membrane.

A polyimide double-sided tape with a thickness of 50 μm was attached to both ends of the lower orientation membrane, and the lower substrate and upper substrate were arranged apart from each other so that the lower orientation membrane and the upper orientation membrane was opposite to each other. Afterwards, the composite was capillaryly injected between the lower orientation membrane and the upper orientation membrane. Before injecting the composite, the composite was sonicated for 1 minute, and the laminate was prepared by injecting the composite at 34° C., which is lower than the phase transition temperature of the aromatic liquid crystalline compound.

### Example 2

A planar anchoring polyimide (PAPI, PIA-5550-02A, JNC) was spin-coated as an anchoring polymer, and a glass substrate coated with the anchoring polymer was heated in an oven at 90° C. for 30 minutes, followed by heating at 200° C. for 2 hours. Then, a plurality of grooves were formed on the PAPI using a rubbing machine (RMS-50-M, Namil Optics) to produce a lower orientation membrane and an upper orientation membrane on one surface of a lower substrate and an upper substrate.

Thereafter, a laminate was prepared in the same method as that of Example 1, except that when capillary injection of a composite was performed between the lower orientation membrane and the upper orientation membrane, the composite was injected in a direction perpendicular to the direction of the grooves contained in the orientation membranes.

### Example 3

A laminate was prepared in the same method as that of Example 1, except that a composite contained 0.15% by weight of NU-1000 and 4′-octyl-4-biphenylcarbonitrile (8CB, Sigma-Aldrich) was used as an aromatic liquid crystalline compound.

### Example 4

A laminate was prepared in the same method as that of Example 2, except that a composite contained 0.15% by weight of NU-1000 and 4′-octyl-4-biphenylcarbonitrile (8CB, Sigma-Aldrich) was used as an aromatic liquid crystalline compound.

### Example 5

A laminate was prepared in the same method as that of Example 1, except that a composite contained 0.3% by weight of Cu₃ (hhtp)₂ (Cu₃ (2,3,6,7,10,11-hexahydroxytriphenylene)₂) as a metal organic framework.

### Example 6

A laminate was prepared in the same method as that of Example 2, except that a composite contained 0.3% by weight of Cu₃ (hhtp)₂ (Cu₃ (2,3,6,7,10,11-hexahydroxytriphenylene)₂) as a metal organic framework.

### Example 7

A composite was prepared by mixing 1,4-bis-[4-(3-acryloyloxypropyloxy)benzoyloxy]-2-methylbenzene (RM257, Synthon Chemicals GmbH & Co. KG) as an aromatic liquid crystalline compound and 4′-pentyl-4-biphenylcarbonitrile (5CB, Sigma-Aldrich) at a weight ratio of 1:19 in 5 ml of an amber glass bottle, followed by adding thereto 0.1 part by weight of 2-dimethoxy-2-phenylacetophenone (Irgacure 651, Sigma-Aldrich) based on 100 parts by weight of the RM257 to produce a mixture in which the aromatic liquid crystalline compound was uniformly mixed, and then adding 0.3% by weight of a Nu-1000 ((Zr₆O₄(OH):(H₂O)₄ (TBAPy)₂)) powder to the mixture.

Thereafter, a polyimide double-sided tape was attached to both ends of a lower orientation membrane in a thickness of 20 μm, and then a lower substrate and an upper substrate were arranged apart from each other such that the lower orientation membrane and the upper orientation membrane were opposite to each other. A laminate was prepared in the same method as that of Example 1, except that the composite was injected between the lower orientation membrane and the upper orientation membrane and the RM257 was polymerized by UV irradiation for 5 minutes.

### Example 8

A lower orientation membrane and an upper orientation membrane was prepared by spin-coating a planar anchoring polyimide (PAPI, PIA-5550-02A, JNC) as an anchoring polymer, heating a glass substrate coated with the anchoring polymer in an oven at 90° C. for 30 minutes, followed by heating at 200° C. for 2 hours, and then forming a plurality of grooves on the PAPI using a rubbing machine (RMS-50-M, Namil Optics) to produce the lower orientation membrane and the upper orientation membrane on one surface of a lower substrate and an upper substrate. Thereafter, a laminate was prepared in the same method as that of Example 7, except that when capillary injection of a composite was performed between the lower orientation membrane and the upper orientation membrane, the composite was injected in a direction perpendicular to the direction of the grooves contained in the orientation membranes.

### Measurement Condition

A Nikon Eclipse LV100N POL microscope equipped with a Nikon Instruments DS-Ri1 camera having a resolution of 1280×1024 pixels was used as an optical microscope.

An image of a scanning electron microscopy and an analysis of EDS (Energy-dispersive X-ray spectroscopy) were observed at 5 keV and 5 μA using SU-8230 from Hitachi.

An image of a fluorescence microscope was observed using Lumencor SPECTRA X Light Engine as a light source.

An image of a polarized optical microscope was observed using LV 100-POL from Nikon.

FIG. 1 is a schematic diagram showing a composite prepared by the method of Example 1.

The composite comprising an anisotropic metal organic framework particle and an aromatic liquid crystalline compound is not oriented at a temperature higher than the phase transition temperature of the aromatic liquid crystalline compound, and exhibits isotropy due to a random arrangement of the composite. However, if the composite is cooled to a temperature lower than the phase transition temperature, the composite shows anisotropy because the aromatic liquid crystalline compound is converted to a nematic phase to be oriented in one direction and the metal organic framework uniformly dispersed in the aromatic liquid crystalline compound is also oriented in one direction by the aromatic liquid crystalline compound. In addition, if the anisotropic composite is heated to a temperature higher than the phase transition temperature of the aromatic liquid crystalline compound, the composite is converted back to isotropy, making it possible to reversibly control the orientation.

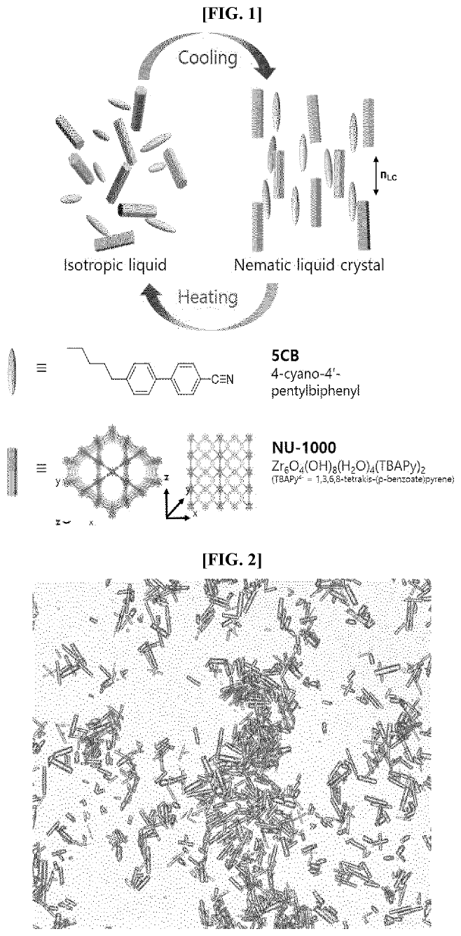

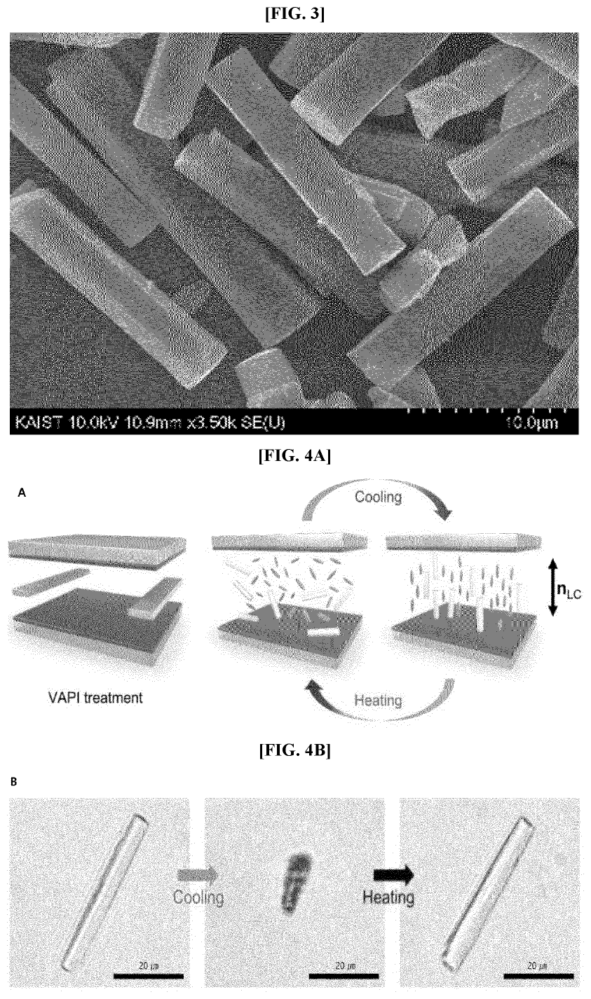

FIG. 2 is an image of an optical microscope of NU-1000, the metal organic framework, and FIG. 3 is an image of a scanning electron microscope of the NU-1000. Since the metal organic framework contains an anisotropic metal organic framework particle in the form of a rod, if the composite is oriented in one direction, a pore contained in the metal organic framework particle is oriented along a longitudinal direction of the metal organic framework, which makes it possible to form a channel. A separation membrane containing the rod-shaped metal organic framework particle has an advantage in that a substance flowing into an active layer passes through the channel at a high rate to improve a performance of the separation membrane.

FIG. 4 are a schematic diagram (FIG. 4A) showing a laminate prepared by the method of Example 1 and an image of an optical microscope (FIG. 4B) showing a change in orientation of the NU-1000. The change in orientation of the composite was observed at a vertical direction of a substrate through an optical microscope. At a temperature higher than the phase transition temperature of 4′-pentyl-4-biphenylcarbonitrile (5CB), the aromatic liquid crystalline compound and the metal organic framework showed isotropy. However, when a laminate was cooled to a temperature lower than the phase transition temperature of 4′-pentyl-4-biphenylcarbonitrile (5CB), the NU-1000 particle was oriented in a vertical direction of the substrate. Also, when the laminate was heated to a temperature higher than the phase transition temperature of 4′-pentyl-4-biphenylcarbonitrile (5CB), the NU-1000 particle that was oriented in the vertical direction of the substrate lost its orientation and was arranged randomly.

FIG. 5 are a schematic diagram (FIG. 5A) showing a laminate prepared by the method of Example 2 and an image of a polarized optical microscope image (FIG. 5B) of a composite. A change in orientation of the composite was observed at a vertical direction of the substrate through the polarized optical microscope. At a temperature higher than the phase transition temperature of 4′-pentyl-4-biphenylcarbonitrile (5CB), an aromatic liquid crystalline compound and a metal organic framework particle were oriented randomly. However, when the composite was cooled to 27° C., which is lower than a range of the phase transition temperature of 4′-pentyl-4-biphenylcarbonitrile (5CB), it can be seen that the composite is oriented in a plane direction of the substrate and a long axis of the metal organic framework is oriented along a direction of the groove created in the lower orientation membrane and the upper orientation membrane.

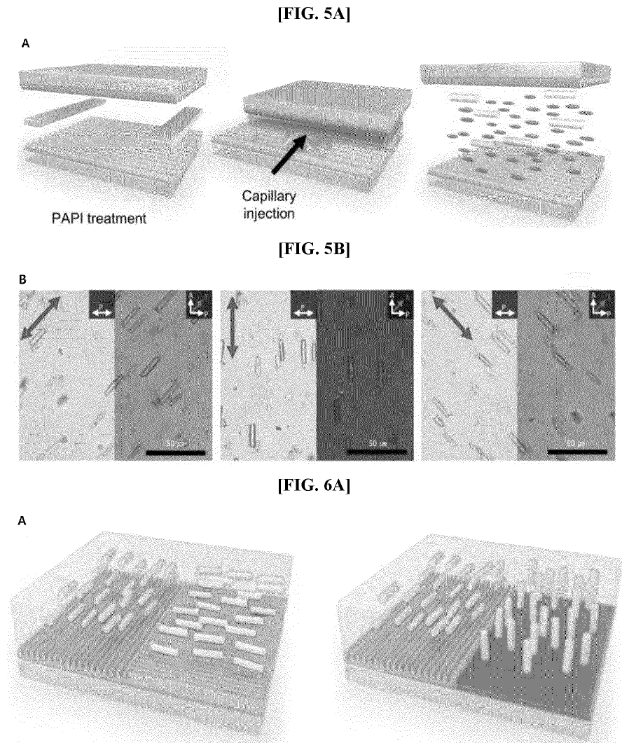

FIG. 6 are a schematic diagram (FIG. 6A) showing a laminate combining the orientation membranes prepared by the methods according to Examples 1 and 2, and is an image of an optical microscope (FIG. 6B) and an image of a fluorescence microscope (FIG. 6C) according to each orientation direction. As shown in FIGS. 6, the two orientation membranes selected from the group comprising a first orientation membrane that does not contain a groove on the upper orientation membrane and the lower orientation membrane, a second orientation membrane that contains a plurality of the grooves aligned in one direction, and a third orientation membrane that contains a plurality of the grooves oriented in a direction different from the second orientation membrane were arranged sequentially, and the composite was also oriented in a different direction depending on a type of the orientation membrane. Even if the laminate is prepared by a combination of the second orientation membrane with the third orientation membrane and the second orientation membrane with the first orientation membrane, it is possible to prepare a laminate in which the composites are oriented in directions different from each other based on an interface of each orientation membrane.

When a rubbing process is performed after applying PAPI as an anchoring polymer, depending on a direction to which a surface of the anchoring polymer is rubbed, the second orientation membrane or the third orientation membrane can be produced by also changing an alignment direction of the grooves formed on the surfaces of the lower orientation membrane and the upper orientation membrane.

As the lower orientation membrane and the upper orientation membrane had different alignment directions of the grooves formed thereon, an orientation direction of the composite contained in the laminate was oriented in the same direction as the alignment direction of the grooves. It was confirmed from the image of the fluorescence microscope in FIG. 6C that in a laminate in which two types of the orientation membranes oriented in different directions were arranged in parallel, a luminescence characteristic of the metal organic framework also was different each other depending on the orientation direction of the orientation membranes. Specifically, the second orientation membrane oriented in a direction parallel to a polarizing plate emitted light, but the first orientation membrane and the third orientation membrane failed to emit light. As such, in case two types of the orientation membranes with different directions of the grooves are arranged in parallel, it can be seen that the orientation direction of the metal organic framework also changes so that when the laminate is observed with a fluorescence microscope using the polarizing plate, a pattern is formed by dividing the metal organic framework into a region that emits light and a region that fails to emit light.

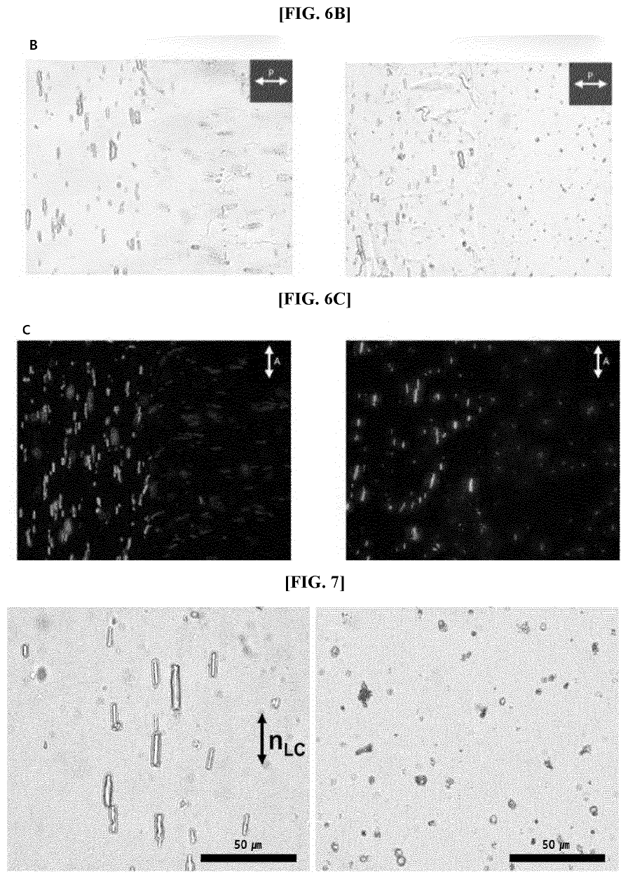

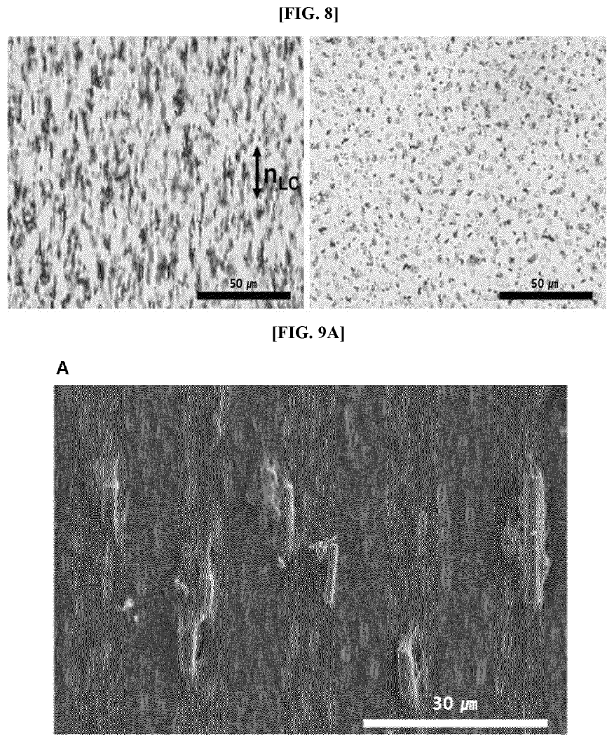

FIG. 7 is an image of a polarized optical microscope of the composites prepared by the methods of Examples 3 and 4, and FIG. 8 is an image of a polarized optical microscope of the composites prepared by the methods of Examples 5 and 6. FIG. 7 shows an observation of the composites of Examples 3 and 4 comprising 4′-octyl-4-biphenylcarbonitrile (8CB) as an aromatic liquid crystalline compound, wherein a metal organic framework was oriented in one direction using the liquid crystalline compound having a nematic phase. It can be seen from FIG. 8 that the composites of Examples 5 and 6 comprising Cu₃ (HHTP)₂ as the metal organic framework were also oriented in one direction at a temperature lower than the phase transition temperature of 5CB.

As shown in FIGS. 4 to 8, an orientation direction of the composite can also be finely controlled depending on a type of the orientation membrane or an alignment direction of the grooves formed in the orientation membrane. In addition, it can be seen that the composite with excellent versatile applications was prepared by orienting the metal organic framework in one direction using the aromatic liquid crystalline compound having the nematic phase, regardless of a specific material of the aromatic liquid crystalline compound and the metal organic framework contained in the composite.

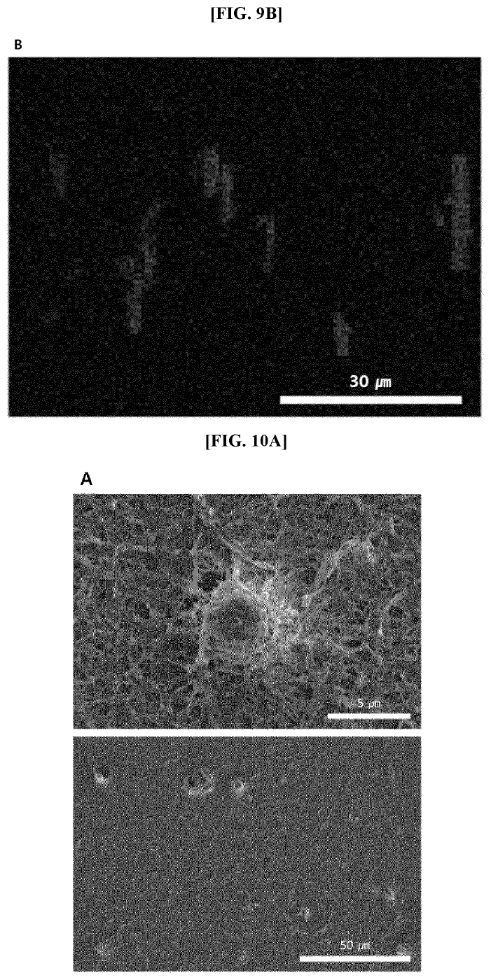

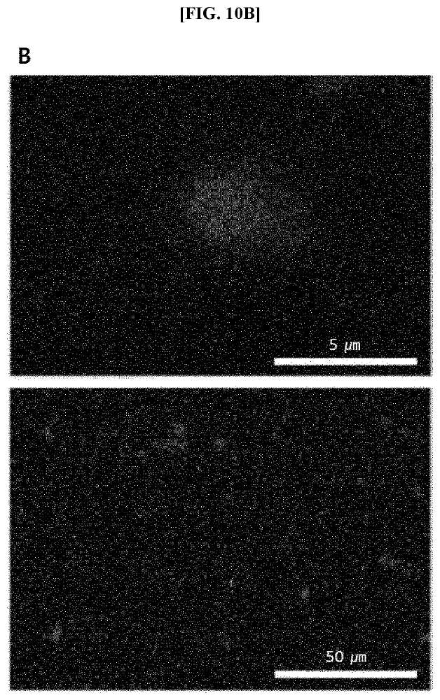

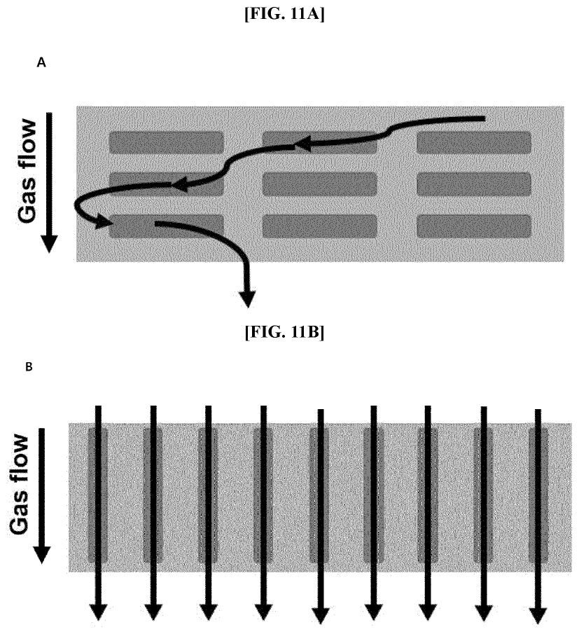

FIGS. 9A and 10A are images of a scanning electron microscope (SEM) of a composite prepared by the methods of Examples 7 and 8, respectively, and FIGS. 9B and 10B are mapping images of an energy-dispersive X-ray spectroscopy (EDS) of zirconium (Zr) contained in NU-1000 of a composite prepared by the methods of Examples 7 and 8, respectively. RM257, which contains an acrylate group, a reactive mesogenic group, at an end thereof, forms a liquid crystal polymer through photopolymerization. Specifically, a composite in which the metal organic framework was uniformly dispersed in the RM257 was injected between the lower orientation membrane and the upper orientation membrane, and was irradiated by an UV ray to polymerize the RM257. Afterwards, in order to observe an interface of the composite, a polyimide tape attached to both ends of the lower orientation membrane was detached to remove the upper substrate containing the upper orientation membrane. A surface of the composite was washed with hexane for 5 minutes to remove unreacted 5CB, and then the composite was observed.

As shown in FIGS. 9 and 10, a NU-1000 crystal was oriented in a plane direction or a vertical direction of the substrate, and the orientation of the metal organic framework was maintained during photopolymerization of the RM257 which contains a polymerizable functional group at its end. Since there is a risk that the orientation of the metal organic framework uniformly dispersed in the RM257 may be damaged during photopolymerization of the RM257, the photopolymerization is performed at a temperature lower than the phase transition temperature so that the metal organic framework is oriented in one direction by the anisotropic 5CB during photopolymerization of the RM257, whereby the metal organic framework is fixedly maintained within the aromatic liquid crystalline polymer matrix in a state which is oriented in one direction. The composite comprising the metal organic framework fixedly oriented within the aromatic liquid crystalline polymer matrix is particularly advantageous as a separation membrane when separating a gas mixture because it can efficiently control a gas permeability and selectivity simultaneously.

Referring to FIGS. 10, the 5CB forms a fiber shape, a plurality of pores were formed through connection between the 5CBs in the fiber shape, and the NU-1000 crystal oriented in one direction was observed in the pores. If a content of the RM257 increases compared to the 5CB, fewer pores are formed due to a decrease in a content of the 5CB, and thus a density and rigidity of the composite increase so that the composite can be separated from the orientation membranes of the laminate.

FIG. 11 are a schematic diagram showing a separation membrane and a gas permeability path according to the present invention. The separation membrane was prepared by stacking a laminate containing an aromatic liquid crystalline compound and a metal organic framework on poly(vinylidenefluoride) (PVDF), a porous support.

Specifically, FIG. 11A is a schematic diagram showing the gas permeability flow of the separation membrane containing the laminate of Example 2, and FIG. 11B is a schematic diagram showing the gas permeability flow of the separation membrane containing the laminate of Example 1. When the metal organic framework was oriented, a channel was formed along a long axis direction of the metal organic framework. It was confirmed that the separation membranes including the laminates of Examples 1 and 2 had a very excellent selectivity to improve a separation performance.

As shown in FIG. 11A, in the laminate of Example 2, the metal organic framework was oriented in a direction parallel to the plane direction of the substrate to allow the channel to be formed in a direction perpendicular to the direction in which the gas diffuses, whereby the gas movement path within the separation membrane became longer to cause a decrease in the permeability. On the other hand, as shown in FIG. 11B, in the laminate of Example 1, a long axis of the metal organic framework was oriented in a direction parallel to the diffusion direction of the gas, and when the gas diffused into the separation membrane containing it, the gas was transmitted at a high rate through the channel formed along the long axis to cause an increase in the permeability.

Therefore, the separation membrane of the present invention comprising the aromatic liquid crystalline compound and the metal organic framework can easily orient the metal organic framework only by controlling the temperature, so that the separation membrane with an excellent separation performance of the gas can be implemented by remarkably increasing the gas permeability through the channel formed by the oriented metal organic framework, simultaneously with providing the high selectivity.

As described above, the present invention was described in association with the specific matters, the limited Examples, and the drawings, but they are provided only to aid the overall understanding of the present invention, and the present invention is not limited to the above Examples. Accordingly, any person who has an ordinary knowledge in the field to which the present invention belongs can make various modifications and variations from the above description.

Therefore, the spirit of the present invention should not be limited to the described Examples, and shall include the scope of the claims to be described below as well as all equivalents or modifications that correspond to the scope of the claims.

What is claimed is:

1. A composite comprising an aromatic liquid crystalline compound and a metal organic framework containing an anisotropic metal organic framework particle,
wherein the metal organic framework is reversibly switched between isotropy and anisotropy oriented in one direction.

2. The composite according to claim 1,
wherein the aromatic liquid crystalline compound contains a thermotropic liquid crystalline compound.

3. The composite according to claim 2,
wherein the metal organic framework has anisotropy at a temperature lower than the phase transition temperature of the aromatic liquid crystalline compound.

4. The composite according to claim 1,
wherein the anisotropic metal organic framework particle is in the form of a rod.

5. The composite according to claim 4,
wherein an aspect ratio of the anisotropic metal organic framework particle is 3 to 15.

6. The composite according to claim 5,
wherein the anisotropic metal organic framework particle has an average pore size of 1 to 5 nm in a longitudinal direction thereof.

7. The composite according to claim 1,
wherein the anisotropic metal organic framework particle is uniformly dispersed in the aromatic liquid crystalline compound.

8. The composite according to claim 3,
wherein the aromatic liquid crystalline compound has a nematic phase at a temperature lower than the phase transition temperature.

9. The composite according to claim 8,
wherein the aromatic liquid crystalline compound further contains a polymerizable functional group, and
the anisotropic metal organic framework particle is fixedly oriented in one direction within an aromatic liquid crystalline polymer matrix formed by polymerizing the aromatic liquid crystalline compound.

10. A laminate comprising:
a lower substrate;
an upper substrate arranged apart opposite to the lower substrate;
a lower orientation membrane located on a top of the lower substrate;
an upper orientation membrane located on a bottom of the upper substrate; and
a composite interposed between the lower orientation membrane and the upper orientation membrane,
wherein the composite comprises an aromatic liquid crystalline compound and a metal organic framework containing an anisotropic metal organic framework particle, the metal organic framework being reversibly switched between isotropy and anisotropy oriented in one direction.

11. The laminate according to claim 10,
wherein the metal organic framework of the composite is oriented in a plane direction of the substrate or in a vertical direction of the substrate.

12. The laminate according to claim 10,
wherein a thickness of the composite is 20 to 80 μm.

13. The laminate according to claim 10,
wherein the orientation membranes include a plurality of grooves oriented in one direction.

14. The laminate according to claim 10,
wherein the upper orientation membrane and the lower orientation membrane include one or more selected from the group comprising a first orientation membrane that does not contain a groove; a second orientation membrane that contains a plurality of grooves oriented in one direction; and a third orientation membrane that contains a plurality of grooves oriented in a direction different from the second orientation membrane.

15. A method for preparing a laminate, comprising the steps of:
(S10) arranging an upper substrate and a lower substrate apart from each other such that an upper orientation membrane formed on one surface of the upper substrate is opposite to an lower orientation membrane formed on one surface of the lower substrate; and
(S20) injecting a composite between the lower orientation membrane and the upper orientation membrane,
wherein the composite comprises an aromatic liquid crystalline compound and a metal organic framework containing an anisotropic metal organic framework particle.

16. The method for preparing the laminate according to claim 15, further comprising:
prior to the step (S10), the steps of applying an anchoring polymer to one surface of the upper substrate and the lower substrates; and
preparing the upper orientation membrane and the lower orientation membrane by forming a plurality of grooves oriented in one direction to the anchoring polymer.

17. The method for preparing the laminate according to claim 15,
wherein the step (S20) is performed at a temperature higher than the phase transition temperature of the aromatic liquid crystalline compound.

18. The method for preparing the laminate according to claim 17, further comprising:
after the step (S20), the step of polymerizing the aromatic liquid crystalline compound at a temperature lower than the phase transition temperature.

19. A separation membrane comprising a porous support and an active layer located on the porous support and containing a composite,
wherein the composite comprises an aromatic liquid crystalline compound and a metal organic framework containing an anisotropic metal organic framework particle, the metal organic framework being reversibly switched between isotropy and anisotropy oriented in one direction.
